(19) United States
(12) Patent Application Publication
(10) Pub. No.: US 2023/0215717 A1
(43) Pub. Date: Jul. 6, 2023

(54) AN ATMOSPHERIC PRESSURE IONISATION SOURCE

(71) Applicant: Micromass UK Ltd, Wilmslow (GB)

(72) Inventors: Arvind Rangan, Singapore (SG); Carl Chen, Singapore (SG); Steven Rocha, Singapore (SG); Enchen Guo, Singapore (SG); Nicola Lumley, Wilmslow (GB); David Douce, Wilmslow (GB); Richard Gallagher, Wilmslow (GB); Kate Whyatt, Wilmslow (GB)

(73) Assignee: Micromass UK Ltd, Wilmslow (GB)

(21) Appl. No.: 17/998,012

(22) PCT Filed: May 5, 2021
(86) PCT No.: PCT/GB2021/051082

§ 371 Date: Nov. 4, 2022

(30) Foreign Application Priority Data
May 5, 2020 (SG) 10202004139T

(51) Int. Cl. H01J 49/16; H01J 49/04

(52) U.S. Cl. CPC H01J 49/168; H01J 49/0404; H01J 49/0477; H01J 49/049

(57) ABSTRACT

An atmospheric pressure ionisation source comprising: an ionisation chamber, comprising an aperture for receiving at least the distal end of a capillary into the ionisation chamber in use, the aperture having a capillary axis; a desolvation heater having a nozzle, for directing a stream of heated gas onto the distal end of the capillary in use, the nozzle having a nozzle axis; a corona discharge device including a corona pin having a corona axis, the corona pin for ionizing a sample in the ionisation chamber in use; and an inlet cone of a mass spectrometer arranged in the ionisation chamber, the inlet cone defining a cone entrance having a cone axis, wherein the cone axis is substantially coaxial with the corona axis and the capillary axis is substantially perpendicular to and intersects with the nozzle axis.

### DESCRIPTION OF INVENTION

The present invention relates to an atmospheric pressure ionisation source.

### BACKGROUND OF THE INVENTION

The invention generally relates to an atmospheric solids analysis probe (ASAP). Such probes, and the associated instrument for use with ASAP, are provided by several manufacturers, including Waters Corporation, Milford, Mass., U.S.A.

ASAP is a useful and relatively cheap tool for use in the direct analysis of volatile and semi-volatile, solid and liquid samples and may be used in the analysis of specialty chemicals, synthetic polymers, energy sources and food.

A sample is introduced into an ion source housing (e.g. an API source), in which the sample is volatilised into the gas phase using a heated gas, such as nitrogen, exiting a desolvation heater and the sample is then ionised using a corona discharge pin. The ionised sample may subsequently be analysed in a mass spectrometer by introduction through a sampling cone thereof.

The sample is introduced into the source by loading it onto the distal end of a capillary. The capillary may comprise a conventional glass capillary. The capillary may be a solid rod, or a tube, with open ends.

Capillaries are fragile and susceptible to contamination. To ensure reliable and accurate analysis, the distal end of the capillary must be inserted into the source in a repeatable manner.

To assist in the loading of a capillary into a source, it is known to provide a holder comprising a clamp mechanism which serves to retain the proximal end of the capillary (opposite the distal end which carries a sample) in the capillary holder. This may provide a user with a more robust method of handling the capillary, and may also assist in the guiding of the capillary into the source. The capillary holder, and/or the source instrument, may comprise a guide mechanism to ensure the correct alignment of the capillary as it is loaded into the source.

When the capillary is arranged in the ion source housing, the distal end of the capillary is arranged adjacent the outlet of a nozzle of the desolvation heater for directing heated gas onto the capillary.

If a significant amount of the sample is not adequately heated by the nozzle, it may subsequently not be effectively volatilised into the gas phase and hence may not be ionised by the corona discharge pin. This may then reduce the speed and accuracy of the subsequent measurement. Ineffective volatilisation through incomplete heating of the sample region may result in extended analysis times, with high mass high boiling point compounds being volatilised over such an extended period that it may manifest as undesirable background in the mass spectrum and subsequent analyses.

There is a desire to provide an improved atmospheric pressure ionisation source.

Accordingly, the present invention provides an atmospheric pressure ionisation source comprising: an ionisation chamber, comprising an aperture for receiving at least the distal end of a capillary into the ionisation chamber in use, the aperture having a capillary axis; a desolvation heater having a nozzle, for directing a stream of heated gas onto the distal end of the capillary in use, the nozzle having a nozzle axis; a corona discharge device including a corona pin having a corona axis, the corona pin for ionizing a sample in the ionisation chamber in use; and an inlet cone of a mass spectrometer arranged in the ionisation chamber, the inlet cone defining a cone entrance having a cone axis, wherein the cone axis is substantially coaxial with the corona axis and the capillary axis is substantially perpendicular to and intersects with the nozzle axis.

In at least one embodiment, the distance between the cone entrance and the capillary axis is within a range of 90 to 110% of the distance between the capillary axis and the corona pin tip.

In at least one embodiment, the distance between the cone entrance and the capillary axis is substantially 2.9 mm and the distance between the capillary axis and the corona pin tip is 2.8 mm.

In at least one embodiment, the distance between the corona axis and the capillary axis is within a range of 50 to 150% of the distance between the capillary axis and the nozzle of the heater.

In at least one embodiment, the distance between the capillary axis and the nozzle of the heater is between 4.4 mm and 6 mm.

In at least one embodiment, the distance between the capillary axis and the nozzle of the heater is 4.775 mm.

In at least one embodiment, the distance between the corona axis and the nozzle is between 10 mm and 11 mm.

In at least one embodiment, the distance between the cone entrance and the tip of the corona pin is in the range of 5.5 mm to 7.5 mm.

In at least one embodiment, the distance between the cone entrance and the tip of the corona pin is in the range of 5.5 mm to 5.9 mm.

In at least one embodiment, the distance between the cone entrance and the tip of the corona pin is 5.7 mm.

In at least one embodiment, the aperture is configured to receive the capillary such that the distal end of the capillary is disposed to intersect the nozzle axis in use.

In at least one embodiment, the aperture is configured to receive the capillary such that the distance between the capillary tip and nozzle axis is 2.25 mm.

In at least one embodiment, the corona axis is substantially perpendicular to and intersects the nozzle axis.

In at least one embodiment, the nozzle of the desolvation heater is configured to direct a curtain of heated gas onto the distal end of the capillary, the curtain having a curtain plane.

In at least one embodiment, the capillary axis is substantially aligned with the curtain plane.

In at least one embodiment, the nozzle comprises a plurality of nozzle apertures arranged linearly, or the nozzle comprises a single elongate aperture.

In at least one embodiment, the curtain has a length of 8.5 mm and a width of 1.64 mm.

In at least one embodiment, the curtain extends by 0.5 mm beyond the tip of the capillary.

In at least one embodiment, the capillary axis is substantially horizontal. In at least one embodiment, the nozzle axis is substantially vertical.

In at least one embodiment, the corona axis is substantially horizontal.

In at least one embodiment, the cone axis is substantially horizontal.

The present invention further provides an atmospheric pressure ionisation source comprising: an ionisation chamber, comprising an aperture for receiving at least the distal end of a capillary into the ionisation chamber in use, the aperture having a capillary axis; a desolvation heater having a nozzle, for directing a stream of heated gas onto the distal end of the capillary in use, the nozzle having a nozzle axis; a corona discharge device including a corona pin having a corona axis, the corona pin for ionizing a sample in the ionisation chamber in use; and an inlet cone of a mass spectrometer arranged in the ionisation chamber, the inlet cone defining a cone entrance having a cone axis, wherein the cone axis is substantially coaxial with the corona axis, the capillary axis is substantially perpendicular to and intersects with the nozzle axis, the distance between the cone entrance and the capillary axis is substantially 2.9 mm and the distance between the capillary axis and the corona pin tip is 2.8 mm, the distance between the capillary axis and the nozzle of the heater is between 4.4 mm and 6 mm, and the distance between the cone entrance and the tip of the corona pin is 5.7 mm.

Embodiments of the present invention will now be described, by way of non-limiting example only, with reference to the figures in which:

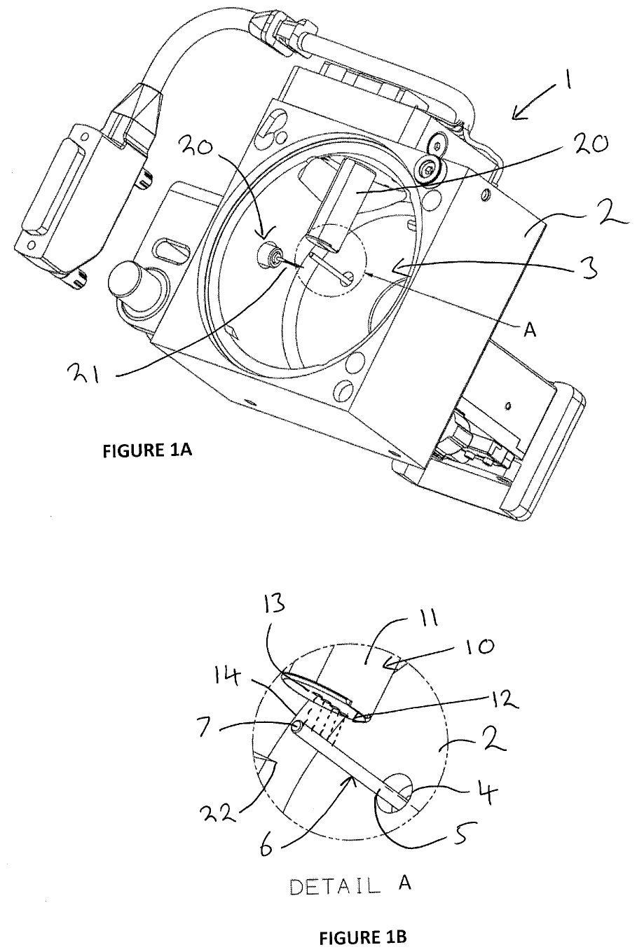

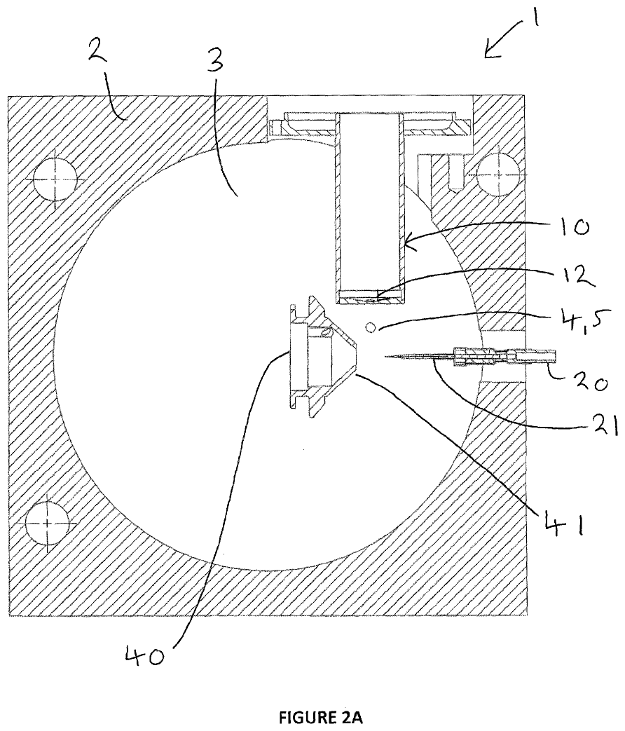

FIG. 1A illustrates an atmospheric pressure ionisation source embodying the present invention;

FIG. 1A is an enlarged view of detail A from FIG. 1A;

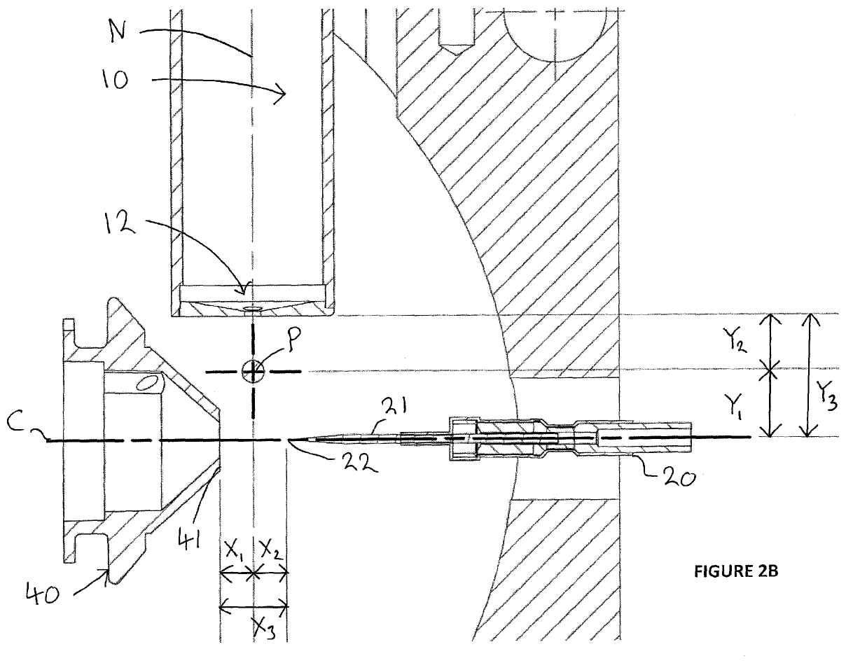

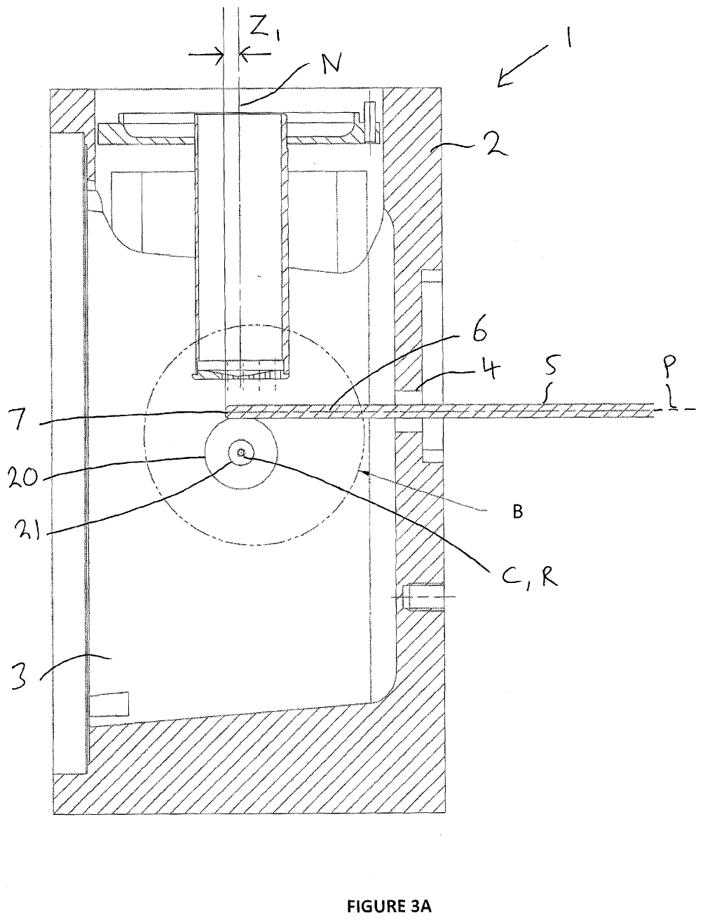

FIG. 2A illustrates a cross-section of the atmospheric pressure ionisation source of FIG. 1a;

FIG. 2B is an enlarged view of part of the arrangement of FIG. 2A;

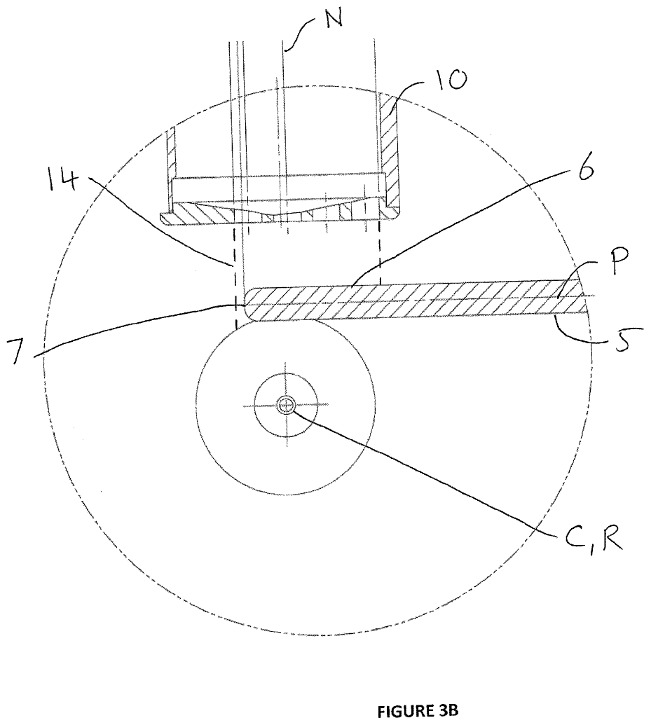

FIG. 3A illustrates a cross-sectional side view of the atmospheric pressure ionisation source of FIGS. 1A and 2A; and

FIG. 3B is an enlarged view of detail B in FIG. 3A.

FIG. 1A illustrates an atmospheric pressure ionisation source 1 embodying the present invention.

The source 1 comprises a housing 2 which defines an ionisation chamber 3 therein. The housing 2 comprises an aperture 4 for receiving at least the distal end 6 of a capillary 5 into the ionisation chamber 3 in use. The aperture 4 has a capillary axis P. The capillary axis P is coaxial with the aperture 4 and thus coaxial with a capillary 5 receivable in the aperture 4 in use. The capillary 5 has a capillary tip 7 at a distal end 6 of the capillary 5.

The atmospheric pressure ionisation source 1 further comprises a desolvation heater 10. The desolvation heater 10 has a generally cylindrical body 11 which contains a heating element (not shown) and a gas source (not shown). The desolvation heater 10 further comprises a nozzle 12 on the end of the cylindrical body 11 of the desolvation heater 10. The nozzle 12 may comprise a plurality of nozzle apertures 13, as shown in FIG. 1B. In use, the desolvation heater 10 directs a stream of heated gas 14 onto the distal end 6 of the capillary 5. The desolvation heater 10 comprises a nozzle axis N. The nozzle axis N is shown as being coaxial with the longitudinal axis of the cylindrical housing 11 of the desolvation heater 10, as best seen in FIG. 2B.

The atmospheric pressure ionisation source 1 further comprises a corona discharge device 20 comprising a corona pin 21. The corona pin 21 comprises a corona tip 22. The corona pin 21 has a corona axis R. The corona pin 21 is for ionizing a sample in the ionisation chamber 3 in use.

The atmospheric pressure ionisation source 1 further comprises an inlet cone 40 of a mass spectrometer (not shown) arranged in the ionisation chamber 3. The inlet cone 40 defines a cone entrance 41 having a cone axis C.

The cone axis C is substantially coaxial with the corona axis R. The capillary axis P is substantially perpendicular to and intersects with the nozzle axis N.

A benefit of the cone axis C being substantially coaxial with the corona axis R is that the sample in the ionisation chamber 3 ionised by the corona pin 21 is directed substantially into the centre of the cone entrance 41 of the inlet cone 40.

A benefit of the capillary axis P being substantially perpendicular to and intersecting the nozzle axis N is that the stream of heated gas 14 exiting the nozzle 12 is caused to be incident on the distal end 6 of the capillary 5, so as to effectively heat a sample held on the distal end 6 of the capillary 5.

As will be appreciated from FIGS. 2A and 2B, the vaporised sample from the capillary 5 will be blown by the stream 14 of heated gases from the nozzle 12 towards the corona discharge device 20 and inlet cone 40. As the vaporised sample enters this zone, it is ionised by the corona discharge pin 21 and then received in the cone entrance 41 of the inlet cone 40 of the mass spectrometer.

The inventors have found that the relative arrangement of the nozzle 12, capillary 5, corona pin 21 and inlet cone 40 is important to ensure the effective heating and ionisation of a sample and the subsequent accurate measurement thereof.

The capillary 5 should be sufficiently close to the nozzle 12 such that the stream 14 of heated gas leaving the nozzle 12 sufficiently heats the sample on the distal end 6 of the capillary 5. At the same time, it must not be so close that the stream 12 of heated gas causes the uncontrolled spraying of heated sample around the ionisation chamber 3.

The inventors have further found that the plume of heated sample should not be directed directly into the cone entrance 41 of the inlet cone 40 before it can be effectively ionised by the corona pin 21.

In at least one embodiment, the capillary axis P is substantially equidistant between the cone entrance 41 and the corona tip 22.

In other words, the distance X₁ between the cone entrance 41 and the capillary axis P is substantially equal to the distance X₂ between the capillary axis P and the corona pin tip 22. In at least one embodiment, X₁ is within a range of 90% to 110% of X₂.

In at least one embodiment, X₁ is 2.9 mm. The distance X₂ is 2.8 mm. The distance X₁ may have a tolerance of ±1 mm. The distance X₂ may have a tolerance of ±0.8 mm.

It has been found that, at least in this embodiment, if X₁ is slightly larger than X₂, it may promote the effective heating and ionisation of the sample before introduction into the cone entrance 41.

In at least one embodiment, the distance X₃ between the cone entrance 41 and the tip 22 of the corona pin 21 (which is equal to the sum of the distances X₁ and X₂) is in the range of 5.5 mm to 7.5 mm. In at least one embodiment, the distance X₃ may be in the range of 5.5 mm to 5.9 mm. In at least one embodiment, the distance X₃ is 5.7 mm. The distance X₃ may have a tolerance of ±1 mm.

In at least one embodiment, the distance Y₁ between the corona axis R and the capillary axis P is within a range of 50% to 150% of the distance Y₂ between the capillary axis P and the nozzle 12 of the heater 10.

In at least one embodiment, the distance Y₂ between the capillary axis P and the nozzle 12 of the heater 10 is between 4.4 mm and 6 mm. In at least one embodiment, the distance Y₂ is 4.775 mm.

In at least one embodiment, the distance Y₃ between the corona axis R and the nozzle 12 is between 10 mm and 11 mm.

In at least one embodiment, the distance Y₃ is 10.7 mm with a tolerance of ±0.25 mm.

In at least one embodiment, the distance Y₁, between the corona axis R and the capillary axis P is between 4.7 mm and 6.3 mm.

FIGS. 3A and 3B illustrate a cross-sectional side view of the atmospheric pressure ionisation source 1 of FIGS. 1 and 2.

The plane of FIGS. 3A and 3B is perpendicular to the plane of FIGS. 2A and 2B. Accordingly, in FIGS. 3A and 3B, the capillary axis P is shown extending across the page. The corona axis R and cone axis C are coaxial and illustrated passing into the page.

In at least one embodiment, the aperture 4 is configured to receive the capillary 5 such that the distal end 6 is disposed within the ionisation chamber 3 so as to intersect the nozzle axis N in use, as shown in FIGS. 3a and 3b. In at least one embodiment, the distance Z₁ between the capillary tip 7 and the nozzle axis N is 2.25 mm.

In at least one embodiment, the corona axis R is substantially perpendicular to and intersects the nozzle axis N, as shown in FIGS. 3a and 3b.

In at least one embodiment, the nozzle 12 of the desolvation heater 10 is configured to direct a curtain 14 of heated gas onto the distal end 6 of the capillary 5, the curtain 14 having a curtain plane (see FIG. 1B). As will be understood with regard to FIGS. 1b and 3b, the plane of the curtain 14 is substantially aligned with the capillary axis P. That is to say that the capillary axis P extends along the plane of the curtain 14. Consequently, by aligning the curtain 14 of heated gas with the capillary axis P, the curtain 14b of heated gas is caused to be incident on the distal end 6 of the capillary 5 so as to heat and substantially vaporise any sample on the distal end 6 of the capillary 5.

In at least one embodiment, the nozzle 12 comprises a plurality of nozzle apertures 13, as shown in FIG. 1b, which creates an elongate curtain 14 of heated gas having a length and a width. Alternatively, the nozzle 12 may comprise a single elongate aperture (not shown) which presents the curtain 14 of gas.

In at least one embodiment, the curtain 14 of heated gas has a length of 8.5 mm and a width of 1.64 mm. The width may alternatively be between 1.60 mm and 1.64 mm. It may be 1.62 mm. In an embodiment where the nozzle 12 comprises four circular nozzle apertures 13, each of the nozzle apertures 13 may have a diameter of 1.62 mm and be spaced at a pitch of 2.3 mm (the distance between the centres of the nozzle apertures 13).

In at least one embodiment, the curtain 14 extends beyond the tip 7 of the capillary 5, to ensure that the entire distal end 6 and tip 7 of the capillary 5 is within the curtain 14 of heated gas. In at least one embodiment, the curtain 14 extends by 0.5 mm beyond the tip 7 of the capillary 5.

In at least one embodiment, the capillary axis P is substantially horizontal. In at least on embodiment, the nozzle axis N is substantially vertical. In at least one embodiment, the corona axis R is substantially horizontal. In at least on embodiment, the cone axis C is substantially horizontal. As noted above, the cone axis C and corona axis R are, in the embodiment illustrated, coaxial with one another.

As will be noted, the distances X₁, X₂ and X₃ referred to herein are measured in the horizontal direction, along the cone axis C and corona axis R. Similarly, distances Y₁, Y₂ and Y₃ are measured in the vertical direction, along the direction of the nozzle axis N.

As will be appreciated from FIG. 3A, the capillary axis P is substantially perpendicular to, and vertically offset from, the cone axis C and corona axis R.

In at least one embodiment, the nozzle axis N intersects all of the capillary axis P, the corona axis R and the cone axis C.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. An atmospheric pressure ionisation source comprising:
an ionisation chamber, comprising an aperture for receiving at least the distal end of a capillary into the ionisation chamber in use, the aperture having a capillary axis;
a desolvation heater having a nozzle, for directing a stream of heated gas onto the distal end of the capillary in use, the nozzle having a nozzle axis;
a corona discharge device including a corona pin having a corona axis, the corona pin for ionizing a sample in the ionisation chamber in use; and
an inlet cone of a mass spectrometer arranged in the ionisation chamber, the inlet cone defining a cone entrance having a cone axis,
wherein the cone axis is substantially coaxial with the corona axis and the capillary axis is substantially perpendicular to and intersects with the nozzle axis.

2. An atmospheric pressure ionisation source according to claim 1, wherein the distance between the cone entrance and the capillary axis is within a range of 90 to 110% of the distance between the capillary axis and the corona pin tip.

3. An atmospheric pressure ionisation source according to claim 2, wherein the distance between the cone entrance and the capillary axis is substantially 2.9 mm and the distance between the capillary axis and the corona pin tip is 2.8 mm.

4. An atmospheric pressure ionisation source according to claim 1, wherein the distance between the corona axis and the capillary axis is within a range of 50 to 150% of the distance between the capillary axis and the nozzle of the heater.

5. An atmospheric pressure ionisation source according to claim 1, wherein the distance between the capillary axis and the nozzle of the heater is between 4.4 mm and 6 mm.

6. An atmospheric pressure ionisation source according to claim 5, wherein the distance between the capillary axis and the nozzle of the heater is 4.775 mm.

7. An atmospheric pressure ionisation source according to claim 1, wherein the distance between the corona axis and the nozzle is between 10 mm and 11 mm.

8. An atmospheric pressure ionisation source according to claim 1, wherein the distance between the cone entrance and the tip of the corona pin is in the range of 5.5 mm to 7.5 mm.

9. An atmospheric pressure ionisation source according to claim 8, wherein the distance between the cone entrance and the tip of the corona pin is in the range of 5.5 mm to 5.9 mm.

10. An atmospheric pressure ionisation source according to claim 9, wherein the distance between the cone entrance and the tip of the corona pin is 5.7 mm.

11. An atmospheric pressure ionisation source according to claim 1, wherein the aperture is configured to receive the capillary such that the distal end of the capillary is disposed to intersect the nozzle axis in use.

12. An atmospheric pressure ionisation source according to claim 11, wherein the aperture is configured to receive the capillary such that the distance between the capillary tip and nozzle axis is 2.25 mm.

13. An atmospheric pressure ionisation source according to claim 1, wherein the corona axis is substantially perpendicular to and intersects the nozzle axis.

14. An atmospheric pressure ionisation source according to claim 1, wherein the nozzle of the desolvation heater is configured to direct a curtain of heated gas onto the distal end of the capillary, the curtain having a curtain plane.

15. An atmospheric pressure ionisation source according to claim 14, wherein the capillary axis is substantially aligned with the curtain plane.

16. An atmospheric pressure ionisation source according to claim 14, wherein the nozzle comprises a plurality of nozzle apertures arranged linearly, or the nozzle comprises a single elongate aperture.

17. An atmospheric pressure ionisation source according to claim 14, wherein the curtain has a length of 8.5 mm and a width of 1.64 mm.

18. An atmospheric pressure ionisation source according to claim 14, wherein the curtain extends by 0.5 mm beyond the tip of the capillary.

19. An atmospheric pressure ionisation source according to claim 1, wherein the capillary axis is substantially horizontal, the nozzle axis is substantially vertical, the corona axis is substantially horizontal or the cone axis is substantially horizontal.

20. (canceled)

21. (Canceled)

22. (Canceled)

23. An atmospheric pressure ionisation source comprising:
an ionisation chamber, comprising an aperture for receiving at least the distal end of a capillary into the ionisation chamber in use, the aperture having a capillary axis;
a desolvation heater having a nozzle, for directing a stream of heated gas onto the distal end of the capillary in use, the nozzle having a nozzle axis;
a corona discharge device including a corona pin having a corona axis, the corona pin for ionizing a sample in the ionisation chamber in use; and
an inlet cone of a mass spectrometer arranged in the ionisation chamber, the inlet cone defining a cone entrance having a cone axis,
wherein the cone axis is substantially coaxial with the corona axis, the capillary axis is substantially perpendicular to and intersects with the nozzle axis, the distance between the cone entrance and the capillary axis is substantially 2.9 mm and the distance between the capillary axis and the corona pin tip is 2.8 mm, the distance between the capillary axis and the nozzle of the heater is between 4.4 mm and 6 mm, and the distance between the cone entrance and the tip of the corona pin is 5.7 mm
